(19) United States
(12) Patent Application Publication
(10) Pub. No.: US 2025/0196449 A1
(43) Pub. Date: Jun. 19, 2025

(54) Method and Apparatus for Induction Welding Thermoplastic Composite Parts

(71) Applicant: The Boeing Company, Arlington, VA (US)

(72) Inventors: Travis Roy Adams, Villa Ridge, MO (US); Andre Eugene Naeger, St. Louis, MO (US); David M. Furdek, Clayton, MO (US)

(21) Appl. No.: 18/545,886

(22) Filed: Dec. 19, 2023

(51) Int. Cl. B29C 65/36; B29C 65/00

(52) U.S. Cl. CPC B29C 65/3668; B29C 66/91221; B29C 66/91411; B29C 66/721

(57) ABSTRACT

Thermoplastic composite laminate parts are induction welded along a weld joint into an integrated structure using an induction coil. The induction coil remains stationary during the welding process and is integrated into a tool configured to match the parts.

### BACKGROUND INFORMATION

### 1. Field

The present disclosure generally relates to joining composite structures, and deals more particularly with a method and apparatus for induction welding thermoplastic composite parts.

### 2. Background

Thermoplastic composite (TPC) parts can be joined together by techniques that result in a unified structure. One technique for joining TPC parts, referred to as induction welding, utilizes an induction coil to heat the parts to their melt temperature, fusing the parts together along a weld joint. Manipulators such as gantry robots are used to move the induction coil over the parts along the weld joint, progressively welding the parts together as the induction coil moves.

The welding technique described above has several disadvantages. The use of a robotic manipulator requires time-consuming motion programming tailored to the particular geometry of the parts. Also, the induction coil typically has a generalized geometry that is not optimized for the shape of the parts, such as a part having curvatures or requiring welds of varying widths. The use of an induction coil having a generalized geometry uses a fixed weld recipe consisting of welding times, temperatures and current flow. The use of a fixed weld recipe may be undesirable in some part applications having unique electrical requirements.

Accordingly, it would be desirable to provide a method and apparatus for induction welding TPC parts which avoid the disadvantages mentioned above.

### SUMMARY

The disclosure relates in general to joining TPC parts, and more specifically to a method and apparatus for induction welding the parts. The disclosed method and apparatus employ an induction coil that is integrated into a tool and remains stationary, fixed within the tool as the induction welding process is carried out. The tool is configured to match the geometry of the parts. The induction coil extends along the entire length of the weld joint between the TPC parts, and welds all sections of the weld joint simultaneously, rather than incrementally, thereby reducing the time required for carrying out the weld.

According to one aspect, apparatus is provided for welding first and second thermoplastic parts together. The apparatus includes a tool configured to press the first and second thermoplastic parts together and an induction coil on the tool. Induction coil is integrated into the tool and is configured to be coupled with a source of electrical power generating an electromagnetic field that welds the first and second thermoplastic parts together through inductive heating. The tool as well as the induction coil remain stationary throughout the welding process and create all sections of a weld joint between the parts simultaneously.

According to still another aspect, a system is provided for making a weld between first and second thermoplastic parts along a weld joint. The system includes a tool, an induction coil, a thermal management system, and a controller. The induction coil is integrated into the tool and remains stationary during the welding process. The thermal management system is configured to control thermal heating/cooling of the thermoplastic parts along the weld joint.

According to another aspect, a method is provided of welding first and second thermoplastic parts together along a weld joint. The method comprises pressing the first and second thermoplastic parts together, and forming a weld joint between them, including melting all sections of the weld joint substantially simultaneously.

One of the advantages of the disclosed embodiments is that the induction coil remains in a fixed, stationary position throughout the welding process, eliminating the need for programming manipulators required to move the induction coil during the welding process. Another advantage is that the need for programming movement of manipulators is eliminated. A further advantage is that all sections of a weld joint are welded at the same time (i.e. simultaneously) thereby reducing the time required to weld the parts together.

The features, functions, and advantages can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and advantages thereof, will best be understood by reference to the following detailed description of an illustrative examples of the present disclosure when read in conjunction with the accompanying drawings, wherein:

FIG. 1 is an illustration of a combined block and cross-sectional view of two TPC parts being induction welded together.

FIG. 2 is an illustration of an enlarged view of the electromagnetic field generated by an induction coil of FIG. 1 relative to the weld joint.

FIG. 3 is an illustration of the area designated as “FIG. 3” in FIG. 2.

FIG. 4 is an illustration of a plan view of one ply of a TPC having a woven, carbon fiber reinforcement.

FIG. 5 is an illustration of a perspective view of an induction coil.

FIG. 6 is an illustration of a perspective view showing one form of the induction coil integrated into a tool.

FIG. 7 is an illustration similar to FIG. 6 but showing another form of an integrated induction coil.

FIG. 8 is an illustration of an induction coil having two different diameters.

FIG. 9 is an illustration of a weld joint having two different widths formed by the induction coil of FIG. 8.

FIG. 10 is an illustration of an end view of a blade stringer, showing the use of tools incorporating induction coils for welding parts of the stringer together using induction welding.

FIG. 11 is an illustration of a cross-sectional view showing TPC blade stringers being induction welded to a TPC wing skin.

FIG. 12 is an illustration of a diagrammatic, cross-sectional view showing a TPC spar being induction welded to a TPC skin.

FIG. 13 is an illustration of a cross sectional view showing a TPC rib being induction welded to TPC skins.

FIG. 14 is an illustration of a functional block diagram of a system for induction welding TPC parts.

FIG. 15 is an illustration of a flow diagram of a method of induction welding TPC parts.

FIG. 16 is an illustration of a flow diagram of aircraft production and service methodology.

FIG. 17 is an illustration of a block diagram of an aircraft.

### DETAILED DESCRIPTION

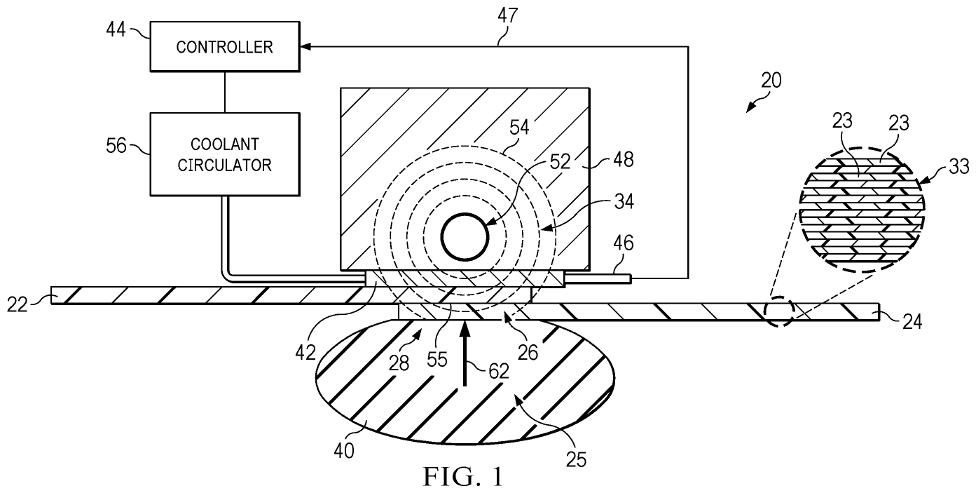

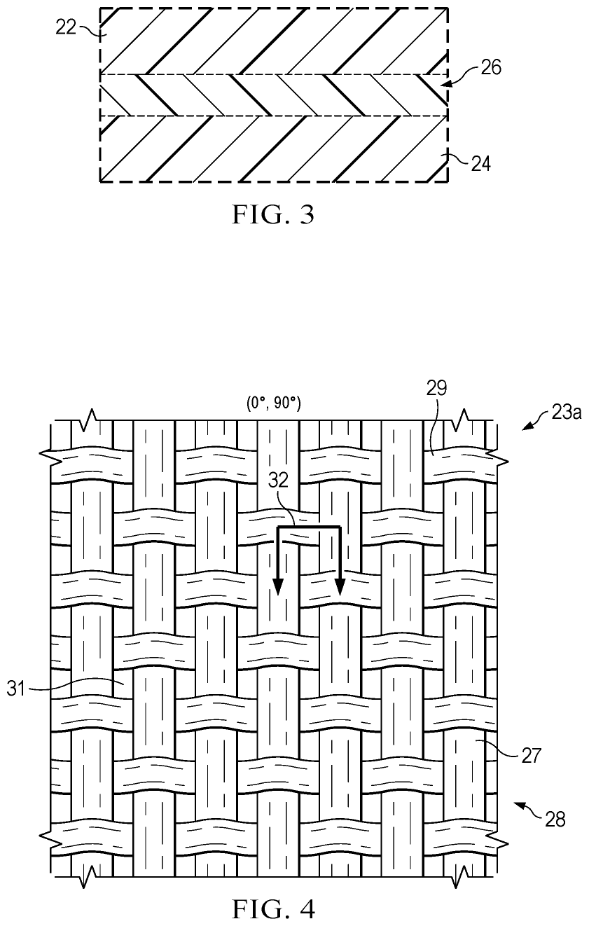

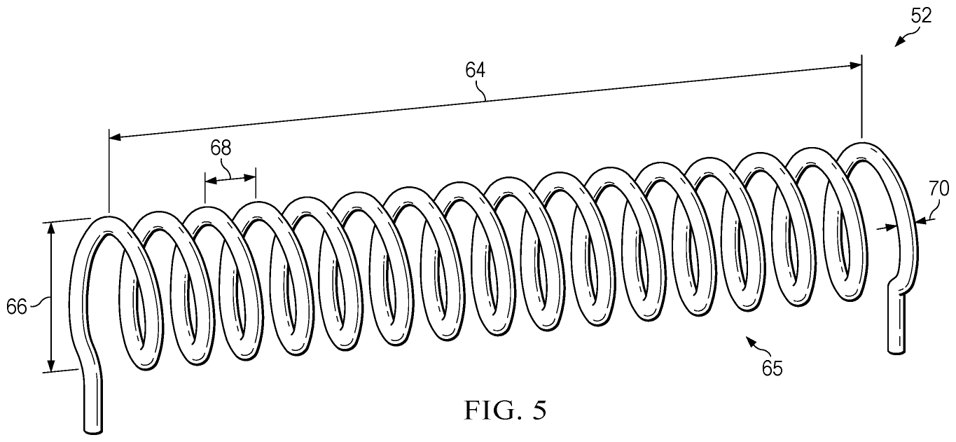

Referring first to FIGS. 1-4, the disclosed embodiments relate to a method and apparatus 20 for induction welding thermoplastic composite (TPC) parts together, thereby forming a unified structure. For example, as shown in FIGS. 1-3 a TPC assembly 25 may comprise a first TPC part 22 induction welded to a second TPC part 24 along faying surfaces 55, forming a weld joint 26. Each of the first TPC part 22 and the second TPC part 24 is a laminate 33 comprising plies 23 of a reinforcement 28 (FIG. 4) held in a thermoplastic matrix 31. The reinforcement 28 shown in FIG. 4 is formed of a woven or knitted, electrically conductive material such as, without limitation, carbon fiber. The thermoplastic matrix 31 may comprise any suitable thermoplastic such as PEEK, PPS, PEI, PAEK and PEKK, to name only a few. In the example shown in FIG. 4, each ply 23 comprises 0° fibers 27 and 90° fibers 29 woven together in overlapping, contacting relationship. However, the reinforcement 28 may include other fiber orientations, such as 45° fibers (not shown). Moreover, the reinforcement 28 may comprise electrically conductive, unidirectional fibers (not shown) having any desired fiber orientation.

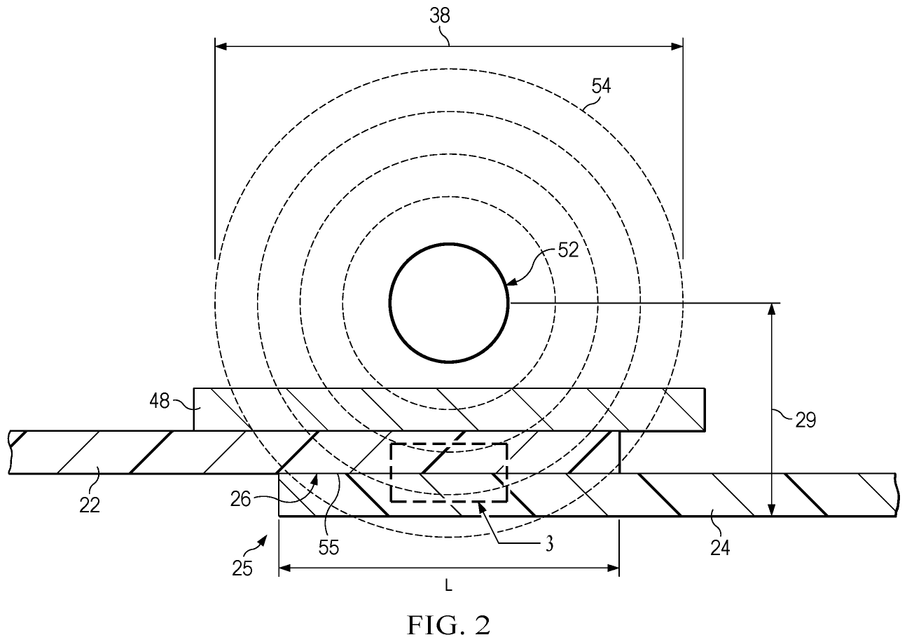

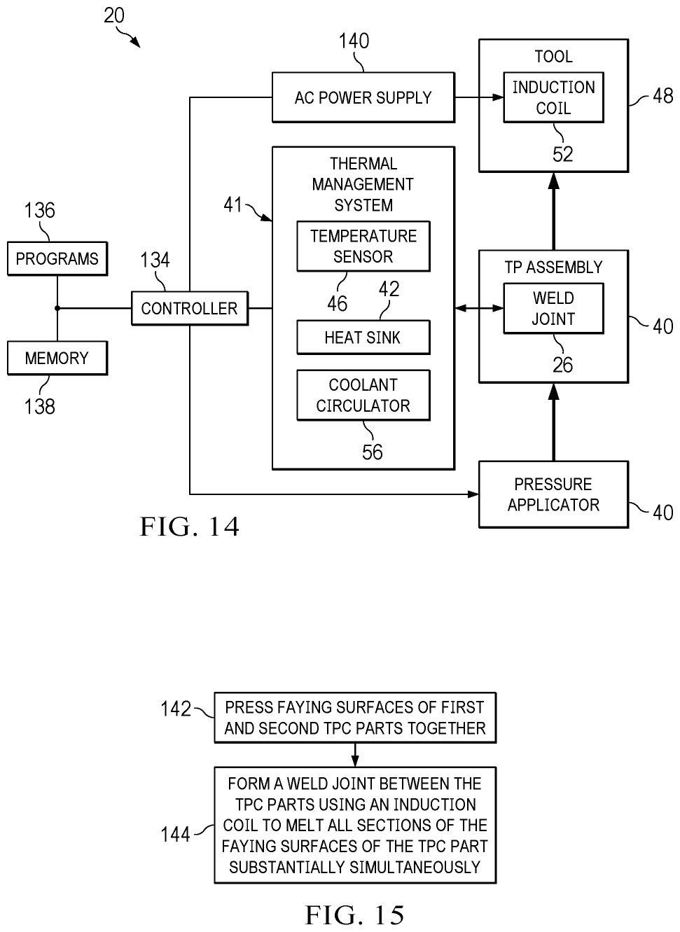

The apparatus 20 broadly comprises an induction coil 52, a tool 48, a heat sink 42 interposed between the tool 48 and the TPC assembly 25, and a pressure applicator 40. As will be discussed below, in some embodiments, the induction coil 52 may be integrated 34 into the tool 48, as shown in FIG. 1, while in other embodiments it may be attached to or otherwise mounted on the tool 48. However, other mounting arrangements are possible for supporting the coil in the desired position extending along the length L of the weld joint 26. In either case, induction coil 52 is fixed 37 on the tool 48 or other support such that it remains stationary during the induction welding process and is inductively coupled 29 with the first TPC part 22 and the second TPC part 24. As will be discussed below, the coil 52 may have any shape matching the tool(s) used to clamp/hold the parts 22, 24 together during the welding process. Also, the coil 52 may take any number of forms, such as repeating coil turns 65 (FIG. 5) or a continuous cylinder or tube (FIGS. 1 and 2). The induction coil 52 is coupled with and energized by an AC power supply 45 (FIG. 14). The induction coil 52 is positioned above the TPC assembly 25 such that the faying surfaces 55 are positioned within an electromagnetic field 54 (EMF) produced by the induction coil 52 when the latter is energized with high-frequency AC power. The heat sink 42 forms part of a later discussed thermal management system 41 (FIG. 14) and is interposed between the TPC assembly 25 and the tool 48. The thermal management system 41 also includes a temperature sensor 46 such as a thermocouple for sensing the temperature of the heat sink 42, and a coolant circulator 56 that draws heat away from the heat sink 42 by passing a coolant through the heat sink 42.

The temperature sensor 46 delivers a temperature signal 47 to a later discussed controller 44. The temperature signal 47 is related to the weld temperature and the temperature of the weld joint. The controller 44 uses the temperature signal 47 to controls electrical power delivered to the induction coil 52 as well as the flow of coolant from a coolant circulator to the heat sink 42. The pressure applicator 40 may comprise any suitable device such as an inflatable bladder producing a pressure 62 that forces the TPC assembly 25 against the tool 48, causing the faying surfaces 55 to be pressed tightly together during the welding process.

The electromagnetic field 54 produced by the induction coil 52 induces electrical currents, known as Eddie currents 32, to flow through the reinforcement 28, which as previously noted, is formed of electrically conductive fibers. The reinforcement 28 effectively acts as a susceptor that absorbs electromagnetic energy produced by the induction coil 52. The Eddie currents 32 resistively heat the thermoplastic matrix 31 to its melting temperature, causing the faying surfaces 55 to melt together and form a weld joint 26 that fuses the TPC assembly 25 into a unified structure.

Referring to FIG. 5, the induction coil 52 is configured to match the shape of the part(s) being welded, and/or to achieve a weld joint having one or more features or characteristics that are unique to the application. In the illustrated example, the induction coil 52 is generally helical in geometry and has a cross-sectional diameter 66 that may be constant or may vary along the length 64 of the induction coil 52. The induction coil 52 has a length 64 that substantially matches the length L of the weld joint 26, and is formed from electrically conductive wire having a diameter (gauge) 70 that is suitable for the application. The induction coil 52 may have any number of coil turns 65 with a pitch 68 (spacing) and cross-sectional diameter 66 that is suitable for the application. Thus, the induction coil 52 is tailored to the geometry of the parts and/or the weld joint 26 by selecting particular values for one or more of the size of the coil turns 65, the cross-sectional diameter 66 of the coil 52, the number of coil turns 65, the size of the induction coil 52, the pitch 68 between the coils and the geometry of the coils. In other embodiments, the induction coil 52 may comprise a tube (FIGS. 1 and 2) or other form of an electrical conductor that is configured to generate an electromagnetic field 54 capable of generating the Eddie currents needed to carrying out the induction welding process.

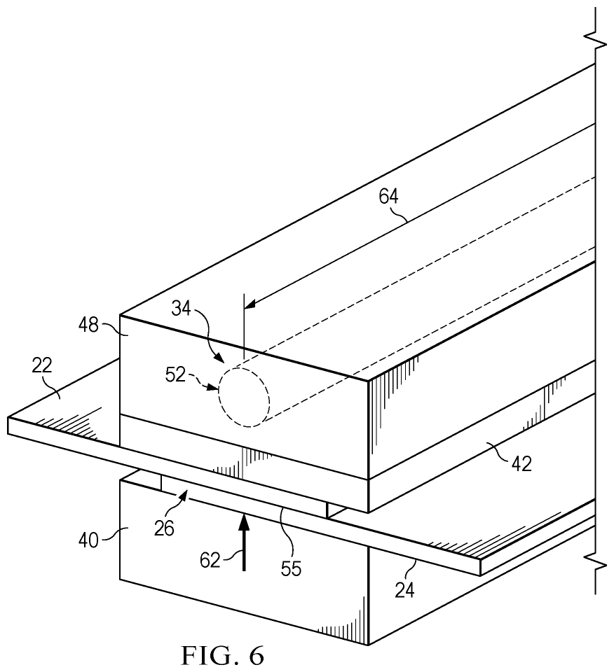

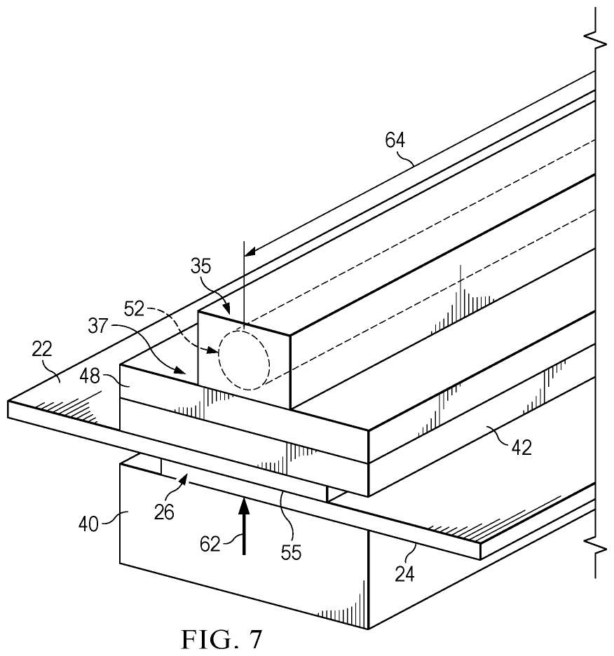

Referring now to FIG. 6, the induction coil 52 may be integrated 34 into the tool 48 which can be formed of any suitable non-magnetic material. In this example, the heat sink 42 is a separate component interposed between the first TPC part 22 and the tool 48, however in other examples, it may be possible to integrate the heat sink 42 into the tool 48. FIG. 7 illustrates an alternate embodiment in which the induction coil 52 is encased 35 in a carrier 72 that is removably attached by any suitable means to the tool 48.

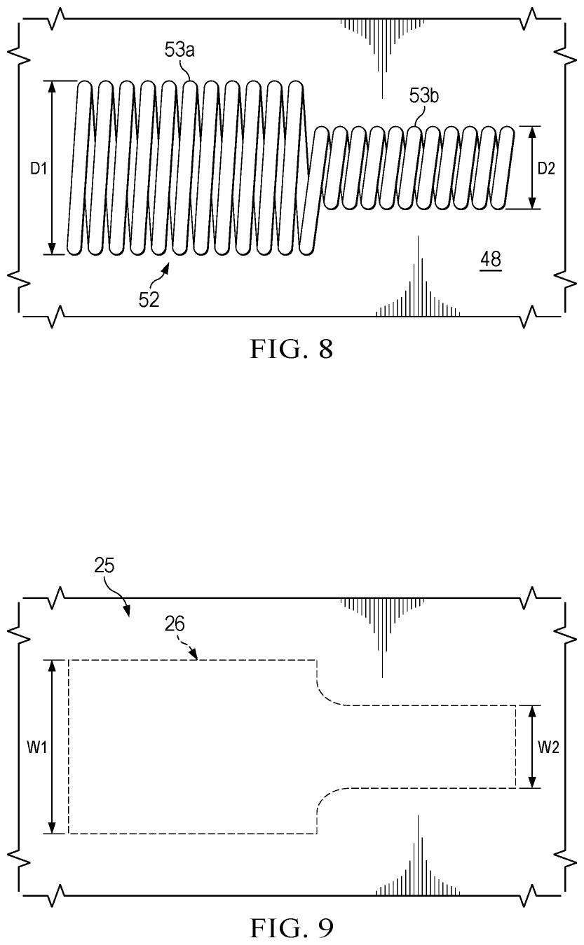

Attention is now directed to FIGS. 8 and 9 which illustrate the use of an induction coil 52 having a varying diameter that produces a weld joint 26 having a width W1, W2 that varies. In the illustrated example, induction coil 52 has two sections, section 53a and section 53b, arranged in series, respectively having differing diameters D1 and D2. Since the width 38 (FIG. 2) of the electromagnetic field 54 is dependent upon the size of the induction coil 52 (which in this case is the diameter of the induction coil 52), the induction coil 52 shown in FIG. 8 produces a welded joint 26 with having two different widths W1 and W2. Thus, induction coil 52 can be configured to produce weld joints 26 of any desired width, including weld joints 26 that continuously vary in width along their length L. Likewise, induction coil 52 can be configured to produce weld joints 26 having a varying thickness by increasing the size of the induction coil 52 in different sections along its length.

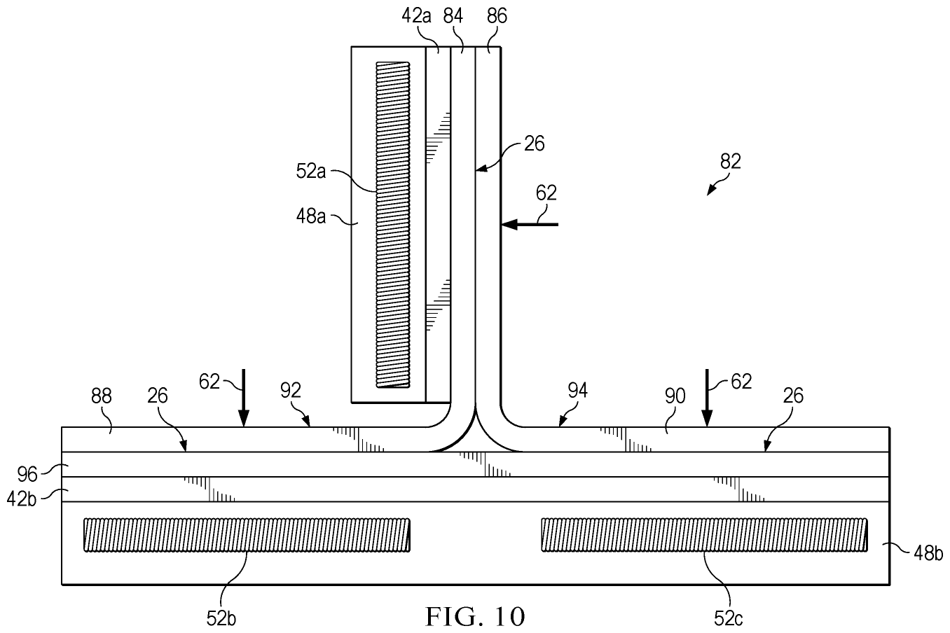

The apparatus 20 can be used to induction weld a variety of TPC parts into integrated structures such as those forming part of an aircraft. For example, FIG. 10 illustrates a blade stringer 82 which can be used to stiffen a skin (not shown). The blade stringer 82 comprises two L-shaped members 92, 94 and a base 96, all formed of a TPC laminate and induction welded together. Blade portions 84, 86 of the L-shaped members 92, 94 are induction welded together using an induction coil 52a that is integrated and remains fixed within a tool 48a. A heat sink 42a is interposed between the tool 48a and blade portion 84. The blade portions 84, 86 are pressed together against the tool 48a by a pressure 62 applied using any suitable force applicator (not shown). Similarly, flange portions 88, 90 of the L-shaped members 92, 94 are induction welded to the base 96 using a tool 48b having separate, integrated induction coils 52b, 52c that are respectively coextensive in length with the flange portions 88, 90.

In the example shown in FIG. 10, a heat sink 42b is positioned between the tool 48b and the base 96, however in other examples, the heat sink 42b may comprise two separate sections (not shown) respectively positioned beneath the flange portions 88, 90. Similarly, the tool 48b may comprise two separate sections. Pressure 62 separately applied to the flange portions 88, 90 force the flange portions 88, 90 against the base 96, and the tool 48b. As a result of this arrangement, the induction coils 52b, 52c generate separate electromagnetic fields (not shown) that weld the flange portions 88, 90 to the base 96. As in the previous examples, the induction coil 52b, and induction coil 52c are integrated into tool 48b. The induction coils 52b, 52c, 52c remain stationary as the L-shaped members 92, 94 and the base 96 are being induction welded into an integrated structure.

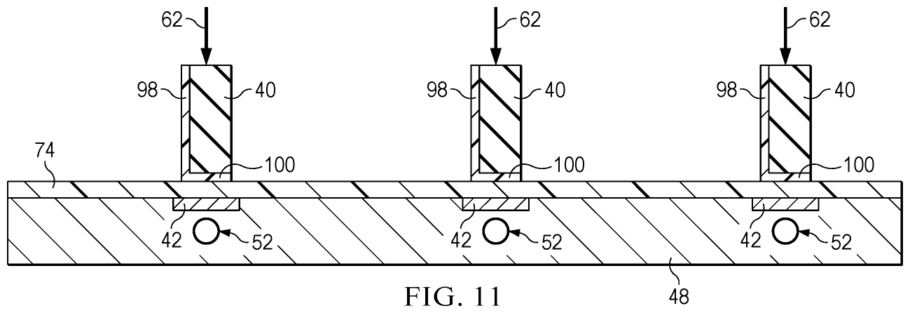

Attention is now directed to FIG. 11 which shows several L-shaped blade stringers 98 having flanges 100 being induction welded to skin 74. Multiple induction coils 52 are integrated into a tool 48 beneath the flanges 100 of skin 74, and remain fixed (stationary) during the welding process. Heat sinks 42 are integrated into the tool 48 and interposed beneath the induction coils 52 and the flanges 100. Pressure applicator 40 applies a pressure 62 that force the flanges 100 against the skin 74 during the induction welding process.

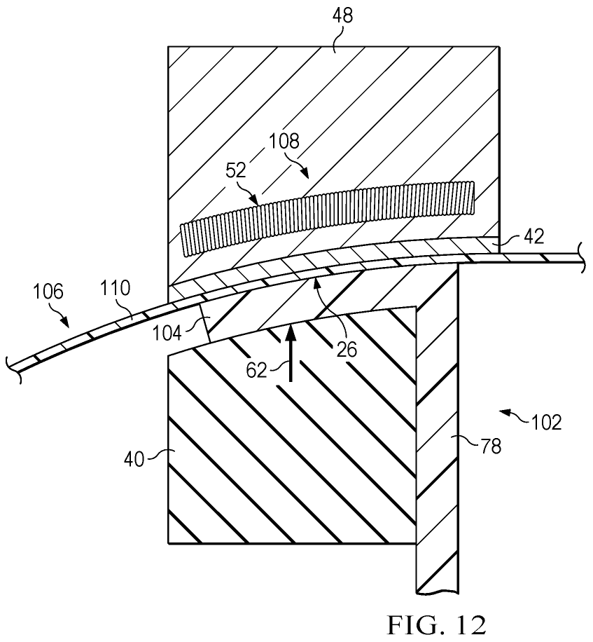

FIG. 12 illustrates another application of the use of the apparatus 20 to induction weld a curved flange 104 of a spar 78 to a skin 110 that has a curvature 106 matching that of the curved flange 104. An induction coil 52 integrated into a tool 48 has a curvature 108 that substantially matches the curvature 106 of the skin 110. The curvature 108 allows the induction coil 52 to evenly heat and weld the flange 100 to the skin 74 along a weld joint 26. As in previous examples, a heat sink 42 is interposed between the tool 48 and the skin 74, while a pressure applicator 40 is used to generate a pressure 62 that presses the flange 80 against the skin 74.

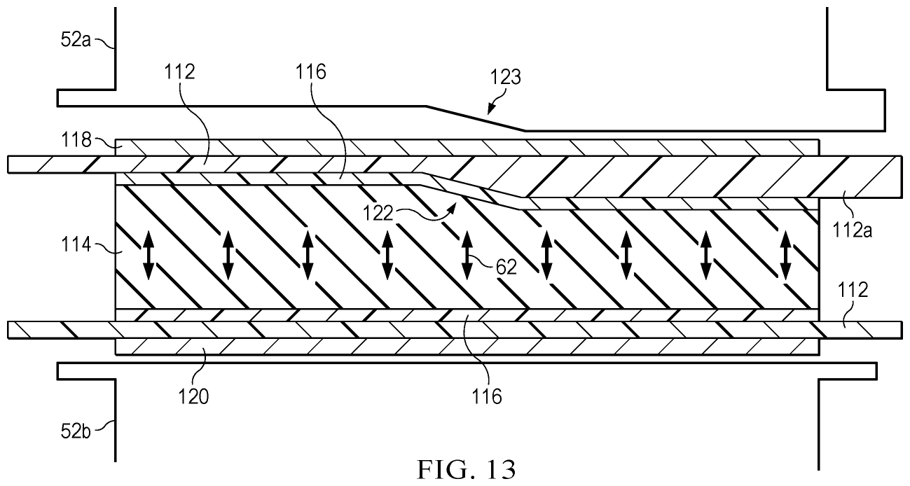

Attention is now directed to FIG. 13 which illustrates a further application of the apparatus 20 used to induction weld a C-shaped rib 116 to wing skins 112 on an aircraft in which the upper wing skin 112a includes a ramp 122 in thickness. An inflatable bladder 114 placed inside the C-shaped rib 116 functions as a pressure applicator 40 which produces a pressure 62 that forces the C-shaped rib 116 against the wing skins 112. A pair of induction coils 52a, 52b integrated into fixed tools (not shown) are respectively positioned above and below the wing skins 112. The induction coils 52a, 52b generate electromagnetic fields (not shown in FIG. 13) that induction weld the C-shaped rib 116 to the wing skins 112. In this example, however, the induction coil 52a is configured with a jog 123 along its length that generally matches the ramp 122 in the wing skin 112. The jog 123 in the induction coil 52a results in uniform heating of the weld joint 26 between wing skins 112 and the C-shaped rib 116. As in previous examples, suitable heat sinks 118, 120 are interposed between the tools containing the induction coils 52a, 52b and the wing skins 112.

FIG. 14 broadly illustrates the components of one embodiment of an apparatus 20 for induction welding TPC laminate parts into an integrated structure. Alternating current of a desired frequency is applied to the induction coil 52 by an AC power supply 140 operated by a controller 44. The controller 44 may comprise a PC (personal computer) or one or more processors (not shown). The controller 44 controls operations based on one or more programs including one or more weld programs stored in a memory 138. The controller 44 also controls operation of the pressure applicator 40 and the thermal management system 41. As previously explained, the thermal management system 41 includes one or more heat sinks 42, a temperature sensor 46 and a coolant circulator 56 that draws heat from the heat sink 42 by passing a coolant through the heat sink 42, reducing the time required to reduce the temperature of the weld joint 26.

Referring now to FIGS. 1-3 and 14, in use, the first TPC part 22 and the second TPC part 24 are assembled together with their faying surfaces 55 in contact with each other, as shown in FIG. 1. A heat sink 42 is then placed over the TPC assembly 25 in the area overlying the faying surfaces 55. A tool 48 containing an integrated induction coil 52 is then placed onto the heat sink 42. A pressure applicator 40 is activated to apply a pressure 62 that presses the first TPC part 22 and the second TPC part 24 together and against the tool 48. The controller 44 then directs the AC power supply 140 to energize the induction coil 52 with AC current. The induction coil 52 generates an electromagnetic field 54 which induces Eddie currents flow through the first TPC part 22 and the second TPC part 24 in the area of the weld joint 26. The Eddie currents heat the first TPC part 22 and the second TPC part 24 to their melt temperature, causing these parts to fuse together along the welded joint 26. During this heating process, the temperature sensor 46 senses the temperature of the heat sink 42 and delivers a temperature signal 47 to the controller 44. When the weld is completed, controller 44 directs the coolant circulator 56 to deliver coolant through the heat sink 42, as necessary, to rapidly cool the weld joint 26. At the end of the weld cycle, the controller 44 directs the AC power supply 142 to remove power from the induction coil 52, and also deactivate the pressure applicator 40, removing the pressure 62 which permits the apparatus 20 to be disassembled.

FIG. 15 broadly illustrates the steps described above for induction welding TPC parts using an induction coil 52 that remains stationary throughout the induction welding process. At 142, faying surfaces 55 of a first TPC part 22 and a second TPC part 24 are pressed together by a pressure applicator 40. Then at 144, a weld joint 26 is formed between the first TPC part 22 and the second TPC part 24 using an induction coil 52 to melt all sections of the faying surfaces 55 substantially simultaneously.

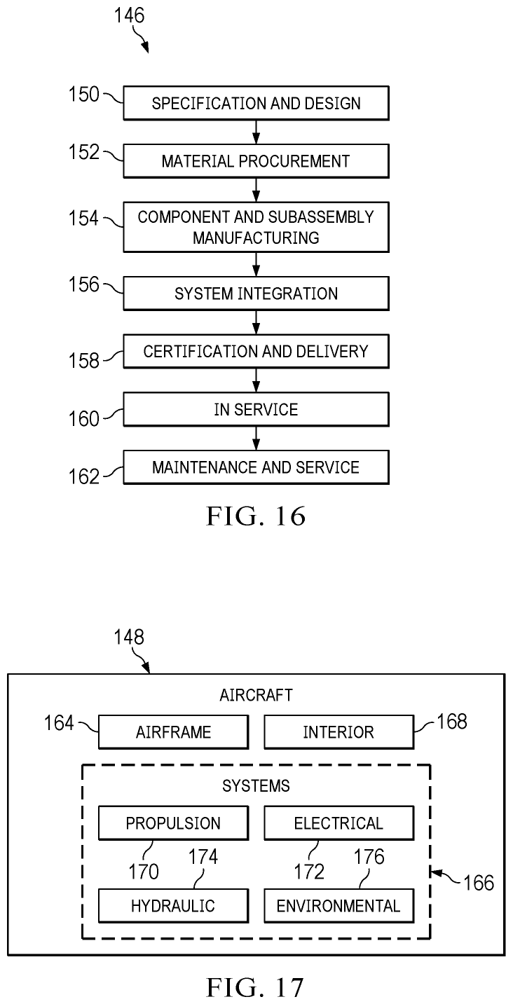

Examples of the disclosure may find use in a variety of potential applications, particularly in the transportation industry, including for example, aerospace, marine, automotive applications and other application where thermoplastic composite laminate parts are joined together to form a unified structure. Thus, referring now to FIGS. 16 and 17, examples of the disclosure may be used in the context of an aircraft manufacturing and service method 146 as shown in FIG. 16 and an aircraft 148 as shown in FIG. 17. Aircraft applications of the disclosed examples may include a variety of structural assemblies and subassemblies such as spars, stringers and other stiffeners. During pre-production, the service method 146 may include specification and design 150 of the aircraft on 148 and material procurement 152. During production, component and subassembly manufacturing 154 and system integration 156 of the aircraft 148 takes place. Thereafter, the aircraft 148 may go through certification and delivery 158 in order to be placed in service 160. While in service by a customer, the aircraft 148 is scheduled for routine maintenance and service 162, which may also include modification, reconfiguration, refurbishment, and so on.

Each of the processes of service method 146 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 17 the aircraft 148 produced by service method 146 may include an airframe 164 with a plurality of high-level systems 166 and an interior 168. The airframe 164 may have any number assemblies of or subassemblies comprising TPC parts that are induction welded together. Examples of high-level systems 166 include one or more of a propulsion system 170, an electrical system 172, a hydraulic system 174, and an environmental system 176. Any number of other systems may be included. Although an aerospace example is shown, the principles of the disclosure may be applied to other industries, such as the marine and automotive industries.

Systems and methods embodied herein may be employed during any one or more of the stages of the aircraft manufacturing and service method 146. For example, components or subassemblies corresponding to component and subassembly manufacturing 154 may be fabricated or manufactured in a manner similar to components or subassemblies produced while the aircraft 148 is in service. Also, one or more apparatus examples, method examples, or a combination thereof may be utilized during the component and subassembly manufacturing 154 and system integration 156, for example, by substantially expediting assembly of or reducing the cost of an aircraft 148. Similarly, one or more of apparatus examples, method examples, or a combination thereof may be utilized while the aircraft 148 is in service, for example and without limitation, to maintenance and service 162.

As used herein, the phrase “at least one of”, when used with a list of items, means different combinations of one or more of the listed items may be used and only one of each item in the list may be needed. For example, “at least one of item A, item B, and item C” may include, without limitation, item A, item A and item B, or item B. This example also may include item A, item B, and item C or item B and item C. The item may be a particular object, thing, or a category. In other words, at least one of means any combination items and number of items may be used from the list but not all of the items in the list are required.

The description of the different illustrative examples has been presented for purposes of illustration and description, and is not intended to be exhaustive or limited to the examples in the form disclosed. Many modifications and variations will be apparent to those of ordinary skill in the art. Further, different illustrative examples may provide different advantages as compared to other illustrative examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. Apparatus for welding first and second thermoplastic parts together, comprising:
a tool configured press the first and second thermoplastic parts together; and
an induction coil on the tool, the induction coil coupled with a source of electrical power generating an electromagnetic field that welds the first and second thermoplastic parts together along a weld joint through inductive heating.

2. The apparatus of claim 1, wherein the induction coil welds the first and second thermoplastic parts together along a weld joint through inductive heating.

3. The apparatus of claim 1, wherein the induction coil has at least one feature that varies along a length of the induction coil, and wherein the at least one feature is related to a geometry of the thermoplastic parts.

4. The apparatus claim 1, wherein the induction coil extends substantially along an entire length of the weld joint between the first and second thermoplastic parts.

5. The apparatus of claim 1, wherein the induction coil is stationary and is inductively coupled with the first and second thermoplastic parts along substantially an entire length of the weld joint.

6. The apparatus of claim 1, wherein the induction coil is integrated into the tool.

7. The apparatus of claim 1, wherein the induction coil is encased within a carrier.

8. The apparatus of claim 7, wherein the carrier is fixed on the tool.

9. The apparatus of claim 1, further comprising:
a thermal management system configured to control heating of the first and second thermoplastic parts along the weld joint.

10. The apparatus of claim 9, wherein the thermal management system includes a heat sink between the induction coil and one of the first and second thermoplastic parts.

11. The apparatus of claim 1, wherein:
the first and second thermoplastic parts have at least one feature that varies along a length of the weld joint, and
the induction coil has at least one feature that varies along the length of weld joint.

12. The apparatus of claim 11, wherein the at least one feature of the weld joint includes one of:
a curvature, and
a width.

13. The apparatus of claim 11 wherein the at least one feature of the induction coil includes one of:
a cross-sectional diameter of the coil turns,
a number of coil turns,
a size of the coil,
a spacing between coil turns, and
a geometry of coil turns.

14. The apparatus of claim 1, further comprising:
a pressure applicator configured to press the first and second thermoplastic parts together along the weld joint.

15. A system for making a weld between first and second thermoplastic parts along a weld joint, comprising:
a tool;
an induction coil configured to be coupled with a source of electrical power and inductively coupled with the first and second thermoplastic parts along the weld joint;
a thermal management system between the first thermoplastic parts and the induction coil, the thermal management system being configured to control thermal heating of the first and second thermoplastic parts along the weld joint; and
a controller configured to control the induction coil and the thermal management system.

16. The system of claim 15, further comprising:
a pressure applicator configured to press the first and second thermoplastic parts together and against the tool.

17. The system of claim 15, wherein the weld joint has a length, and the induction coil extends along the length of the weld joint.

18. The system of claim 17, wherein the induction coil is stationary and is fixed on the tool.

19. The system of claim 15, wherein the induction coil is integrated into the tool.

20. The system of claim 15, wherein the thermal management system includes a heat sink between the first and second thermoplastic parts, and the tool.

21. The system of claim 15, wherein the thermal management system includes a temperature sensor coupled with the controller and configured to sense the temperature of the weld joint.

22. The system of claim 15, wherein the induction coil includes at least one feature that varies along a length of the induction coil.

23. The system of claim 22, wherein the at least one feature includes one of:
a curvature,
a width,
a number of coil turns,
a spacing between coil turns.

24. A method welding first and second thermoplastic parts along a weld joint, comprising:
pressing the first and second thermoplastic parts together; and
forming a weld between the first and second thermoplastic parts, including melting all sections of the first and second thermoplastic parts along the weld joint simultaneously.

25. The method of claim 24, wherein melting all sections of the first and second thermoplastic parts along the weld joint is performed by inductively heating the first and second thermoplastic parts.

26. The method of claim 25, wherein inductively heating the first and second thermoplastic parts includes:
electrically energizing an induction coil,
inductively coupling the induction coil with the first and second thermoplastic parts.

27. The method of claim 24, further comprising:
controlling a temperature of the weld joint.

28. The method of claim 27, wherein controlling the temperature of the weld joint is performed using a thermal management system.

29. A method welding first and second thermoplastic parts along a weld joint, comprising:
pressing the first and second thermoplastic parts together; and
controlling an induction weld temperature along each portion of the weld joint simultaneously.

30. The method of claim 29, wherein controlling the induction weld temperature includes:
placing a heat sink against the weld joint, and
cooling the heat sink.

31. The method of claim 30, wherein controlling the induction weld temperature includes:
sensing a temperature of the heat sink, and
wherein cooling the heat sink is based on the temperature of the heat sink.
